(19) United States
(12) Patent Application Publication
(10) Pub. No.: US 2016/0138137 A1
(43) Pub. Date: May 19, 2016

(54) ALUMINUM ALLOY FOR ENGINE PISTON OF AUTOMOBILE AND METHOD FOR PRODUCING THE SAME

(71) Applicant: HYUNDAI MOTOR COMPANY, Seoul (KR)

(72) Inventor: Hoon Mo PARK, Seongnam-si (KR)

(21) Appl. No.: 14/708,156

(22) Filed: May 8, 2015

(30) Foreign Application Priority Data
Nov. 19, 2014 (KR) 10-2014-0161586

(51) Int. Cl. C22C 21/04; F02F 3/00

(52) U.S. Cl. CPC C22C 21/04; F02F 3/0084

(57) ABSTRACT

An aluminum alloy for an engine piston of an automobile may be composed of Ti, B, Cu and the balance of Al and may include a TiB₂ phase as a reinforcing phase. A composition weight ratio of Ti:B:Cu is 0.5 to 2.5:1:1 to 1.3. The aluminum alloy may have excellent elasticity, thermal properties, and formability by maximizing a generation of a TiB₂ reinforcing phase.

### CROSS-REFERENCE(S) TO RELATED APPLICATIONS

This application claims priority to Korean Patent Application No. 10-2014-0161586, filed on Nov. 19, 2014 in the Korean Intellectual Property Office, the entire contents of which are incorporated herein for all purposes by this reference.

### BACKGROUND OF THE INVENTION

1. Field of the Invention

The present disclosure relates to an aluminum alloy for an engine piston of an automobile and a method for producing the same, and more particularly, to an aluminum alloy for an engine piston of an automobile and a method for producing the same capable of making elasticity, thermal properties, and formability excellent by maximizing a generation of a TiB₂ phase which is a reinforcing phase.

2. Description of Related Art

Generally, an engine for an automobile is a representative internal combustion engine which obtains power by introducing air and fuel into a combustion chamber and combusting the air and fuel.

A high-speed reciprocating piston is mounted in a cylinder of the engine for the automobile. The piston is exposed to and propelled by a high-temperature, high-pressure combustion gas which is generated from the combustion chamber so as to rotate a crank shaft through a connecting rod.

As such, the piston is driven under severe conditions as a piston head is exposed to a high-temperature (2000° C. or more) combustion gas, the piston is shocked by a high pressure (30 to 40 kg/cm²) and causes a considerable friction due to the high-speed reciprocating motion (10 to 20 m/s) within the cylinder, and the like.

Therefore, the piston needs to be manufactured to sufficiently exert its function even under the severe conditions and made of a material which is light and solid and has excellent thermal conductivity and heat resistance.

Recently, in material industry, automobile industry and the like, producing a structural material having eco-friendliness, reasonable cost, and efficient energy saving needs to be implemented, and thus various improvements of quality are required. For this purpose, improvements for development, conversion, and the like of lightweight materials have been researched.

Therefore, an engine piston of an automobile has mainly been manufactured by forging an aluminum alloy billet which is produced by continuously casting an aluminum-based alloy which is light and is relatively easily cast.

However, the typical aluminum alloy is seldomly applied due to an elastic limit and has formability which is difficult to forge. Therefore, technology for improving elasticity and formability of a material is simultaneously required.

The related art forms a reinforcing phase, such as metal-based compound or carbon nano tube (CNT), in a powder form to improve the elasticity of the aluminum alloy, but may have a limitation in price competition.

Further, a problem of loss, wettability, and dispersion in Al molten metal occurs at the time of injecting the reinforcing phase in the powder form in the casting process. In the case of adding only the reinforcing phase without improving a base alloy, a problem of an increased cost, difficulty in a process control, and the like occur due to an increase in an addition of the reinforcing phase to achieve the targeted elasticity.

Therefore, a need exists for a technology for maximizing a generation of boride compound which plays the most important role in improving the elasticity and uniformly dispersing the boride compound generated by a spontaneous reaction in the aluminum molten metal.

An aluminum alloy, which has more excellent elasticity over the typical aluminum alloy without using an expensive material such as carbon nano tube (CNT) and which may be applied in all the general casting processes including high-pressure casting, is known in detail in Korean conventional art entitled “Aluminum Casting Material Comprising Titanium Boride And Manufacturing Method Of The Same” and the like which is the related art.

However, the related art does not solve the problem of loss, wettability, and dispersion in the Al molten metal at the time of injecting the reinforcing phase in the powder form and the problem of the increase in manufacturing cost and the difficulty in the process control due to the increase in the addition of the reinforcing phase.

The Description of Related Art is provided only for assisting in the understanding for the background of the present invention and should not be considered as corresponding to the related art known to those skilled in the art.

### SUMMARY OF THE INVENTION

An embodiment of the present invention is directed to an aluminum alloy for an engine piston of an automobile and a method for producing the same having excellent thermal properties such as thermal conductivity and thermal expandability, formability, and elasticity by optimizing a composition ratio to control a generation of an AlB₂ phase while maximizing a generation of a TiB₂ phase which is a reinforcing phase.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, there is provided an aluminum alloy for an engine piston of an automobile. The aluminum alloy may be composed of Ti, B, Cu and the balance of Al and may include a TiB₂ phase as a reinforcing phase. A composition weight ratio of Ti:B:Cu is 0.5 to 2.5:1:1 to 1.3.

The aluminum alloy may be composed of Si: 11 to 14 wt %, Ti: less than 2.5 wt % (except for 0), B: less than 1.5 wt % (except for 0), Cu: 0.5 to 1.5 wt %, and the balance: Al. The composition weight ratio of Ti:B:Cu may be set to satisfy 0.5 to 2.5:1:1 to 1.3.

The aluminum alloy may be composed of Mn: 1 to 1.5 wt %, Ti: less than 2.5 wt % (except for 0), B: less than 1.5 wt % (except for 0), Cu: 0.5 to 1.5 wt %, and the balance: Al. The composition weight ratio of Ti:B:Cu may be set to satisfy 0.5 to 2.5:1:1 to 1.3.

In accordance with another embodiment of the present invention, a method for producing an aluminum alloy may include steps of: charging Al—Ti master alloy, Al—B master alloy or 75 wt % of Al salt compound in Al molten metal which is received in a melting furnace, in which Ti: less than 2.5 wt % (except for 0), B: less than 1.5 wt % (except for 0), Cu: 0.5 to 1.5 wt %, and the composition weight ratio of Ti:B:Cu is set to satisfy 0.5 to 2.5:1:1 to 1.3; and agitating the molten metal using an agitator so as to generate and disperse a TiB₂ phase which is a reinforcing phase by a spontaneous reaction.

The length of the agitator may be set to be 0.4 times or more than a diameter of the melting furnace. In the step of agitating, the molten metal may be agitated at a speed of 500 rpm or more.

The Al—Ti master alloy may be composed of Ti: 5 to 20 wt % and the balance: Al. The Al—B master alloy may be composed of B: 3 to 10 wt % and the balance: Al.

### BRIEF DESCRIPTION OF THE DRAWINGS

FIG. 1 is a diagram illustrating characteristics for each kind of reinforcing phases and elasticity contribution depending on the characteristics.

### DESCRIPTION OF SPECIFIC EMBODIMENTS

Hereinafter, exemplary embodiments of the present invention will be described in detail with reference to the accompanying drawings. However, the present invention is not limited to these exemplary embodiments. For reference, the reference numerals will be used to describe substantially the same components. Under this rule, a description may be provided while citing a content shown in other drawings and a content well-known to those skilled in the art or a repeated content may be omitted.

Exemplary embodiments of the present invention relate to an aluminum alloy for an engine piston of an automobile and a method for producing the same, and may obtain the aluminum alloy for an engine piston of an automobile having the excellent thermal properties such as thermal conductivity and thermal expandability of a material, formability, and elasticity by optimizing the composition ratio of Ti, B, and Cu to optimize the generation of the AlB₂ phase and suppress the generation of Al₃Ti while maximizing the generation of the TiB₂ phase which is the reinforcing phase.

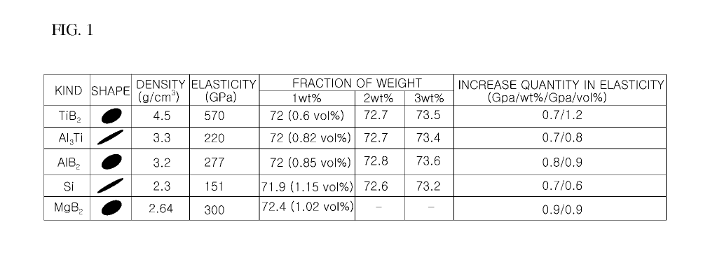

FIG. 1 is a diagram illustrating characteristics for each kind of reinforcing phases and elasticity contribution depending on the characteristics using a Digimat program.

As illustrated in FIG. 1, the elasticity contribution is determined simply by elasticity of a reinforcing phase itself as well as by a composite action of a shape and a density of the reinforcing phase, etc., and therefore even though the elasticity of the reinforcing phase itself is large, it may be appreciated that an increase rate in elasticity may be changed depending on characteristics such as density.

Meanwhile, the exemplary embodiments of the present invention relate to an aluminum alloy for an engine piston of an automobile. Here, to improve stiffness and noise, vibration and harshness (NVH) characteristics, elasticity and formability need to be excellent.

Further, in the case of parts such as a piston which are used under severe conditions such as high temperature and high pressure, thermal conductivity and thermal expandability need to be considered.

Therefore, in the aluminum alloy for an engine piston of an automobile in accordance with the exemplary embodiment of the present invention, a shape of the aluminum alloy relatively approaches a spherical shape, and thus the TiB₂ phase having the high increase rate in elasticity and the excellent thermal conductivity and expandability may be used as the reinforcing phase.

Meanwhile, the aluminum alloy for an engine piston of an automobile in accordance with the exemplary embodiment of the present invention is formed to have a composition including Ti, B, and Cu, in which a composition ratio of Ti:B:Cu may be set to satisfy 0.5 to 2.5:1:1 to 1.3 as a weight ratio.

The reason is that when Ti and B are added to aluminum, the TiB₂ phase and the Al₃Ti phase having the highest contribution to the elasticity may be formed as the reinforcing phases, and when the composition ratio of Ti:B:Cu is set to satisfy 0.5 to 2.5:1:1 to 1.3, it is possible to make thermal properties such as thermal conductivity, elasticity, and formability excellent by maximizing the generation of TiB₂ phase while suppressing the generation of Al₃Ti phase.

The aluminum alloy for an engine piston of an automobile in accordance with the exemplary embodiment of the present invention may be composed of Si: 11 to 14 wt %, Ti: less than 2.5 wt % (except for 0), B: less than 1.5 wt % (except for 0), Cu: 0.5 to 1.5 wt %, and the balance: Al, in which the composition ratio of Ti:B:Cu may be set to satisfy 0.5 to 2.5:1:1 to 1.3.

Therefore, an Al—Si-based aluminum alloy may have thermal properties such as thermal conductivity and a coefficient of thermal expansion similar to those of a commercial 4000 series aluminum alloy containing 11 to 14 wt % of Si, but have improved elasticity and formability over the commercial 4000 series aluminum alloy.

Further, an aluminum alloy for an engine piston of an automobile in accordance with another exemplary embodiment of the present invention may be composed of Mn: 1 to 1.5 wt %, Ti: less than 2.5 wt % (except for 0), B: less than 1.5 wt % (except for 0), Cu: 0.5 to 1.5 wt %, and the balance: Al, in which the composition weight ratio of Ti:B:Cu may be set to satisfy 0.5 to 2.5:1:1 to 1.3.

Therefore, an Al—Si-based aluminum alloy may have thermal properties such as thermal conductivity and a coefficient of thermal expansion similar to those of a commercial 3000 series aluminum alloy containing 1 to 1.5 wt % of Mn, but have improved elasticity and formability over the commercial 3000 series aluminum alloy.

That is, the exemplary embodiments of the present invention are based on composition components of the commercial 3000 series aluminum alloy and the commercial 4000 series aluminum alloy which are used to manufacture parts such as the existing engine piston and cooling pipe of an automobile which are used under severe conditions, but the composition weight ratio of Ti:B:Cu is set to satisfy 0.5 to 2.5:1:1 to 1.3 to maximize the generation of the TiB₂ phase which is a reinforcing phase, thereby improving the formability and the elasticity while preventing the thermal properties from reducing.

In this case, the content of Ti may be limited to be less than 2.5 wt % (except for 0).

The reason is that when a content of Ti is equal to or more than 2.5 wt %, the formability of the material may be reduced due to the excessive generation of the TiB₂ phase and the Al₃Ti phase which is the reinforcing phase having poor formability and impact properties.

Meanwhile, the content of B may be limited to be less than 1.5 wt % (except for 0).

The reason is that when the content of B is equal to or more than 1.5 wt %, the thermal properties of the material may be reduced due to the excessive generation of the AlB₂ phase which is the reinforcing phase having good elasticity and formability but poor thermal properties such as thermal conductivity.

Further, the content of Cu may be limited to 0.5 to 1.5 wt %. The reason is that when a content of Cu is equal to or less than 0.5 wt %, the elasticity is reduced, and when the content of Cu is equal to or more than 1.5 wt %, thermal stability is improved, but a Al₇Cu₄Ni phase which is a reinforcing phase is equal to or more than 1 wt % to reduce thermal conductivity and thus a thermal conduction loss may be increased.

TABLE 1

| | Fraction Of Reinforcing Phase | | | | | | | | | |
|---|---|---|---|---|---|---|---|---|---|---|
| Ti:B:Cu | TiB₂ | AlB₂ | Al₃Ti | Si | Al₅Cu₂Mg₈Si₆ | Al₉Ti₂ | AlFeSi | Al₇Cu₄Ni | Al₁₃Cr₄Si₄ | Mg₂Si |
| 2.3:1:0 | 3.21 | — | 0.21 | 12.43 | — | 5.48 | 1.95 | — | 0.32 | 2.05 |
| 2.3:1:0.5 | 3.21 | — | 0.21 | 12.2 | 2.43 | 5.48 | 1.95 | — | 0.32 | 0.85 |
| 2.3:1:1 | 3.21 | — | 0.21 | 12.1 | 4.17 | 5.4 | 1.97 | 0.18 | 0.32 | — |
| 2.3:1:1.3 | 3.21 | — | 0.21 | 12.03 | 4.17 | 5.1 | 2.07 | 0.77 | 0.32 | — |
| 2.3:1:1.5 | 3.21 | — | 0.21 | 12.03 | 4.17 | 4.91 | 2.13 | 1.17 | 0.32 | — |
| 2.3:1:2 | 3.21 | — | 0.21 | 12.0 | 4.17 | 4.42 | 2.28 | 2.16 | 0.32 | — |
| 2:2:1.3 | 2.9 | 2.46 | — | 12.03 | 4.17 | 5.1 | 2.07 | 0.78 | 0.32 | — |

TABLE 2

| | | | | | | | | | | | | | | | | | Thermal | | |
|---|---|---|---|---|---|---|---|---|---|---|---|---|---|---|---|---|---|---|---|
| | | | | | | | | | | | | | | | | | Conduc- | Melt- | |
| | | | | | | | | | | | | | Latent | Tensile | Yield | Tension/ | tivity | ing | Den- |
| | | | | | | | | | | | Modulus | DAS | Heat | Strength | Strength | Yield | 300° C. | Point | sity |
| Ti:B | Si | Fe | Cu | Mn | Mg | Cr | Zn | Ti | B | Al | Gpa | μM | J/g | MPa | MPa | Difference | W/mK | ° C. | g/cm³ |
| 1:1 | 13.5 | 1 | 1.3 | 1.3 | 0.1 | 1.3 | 0.3 | 1 | 1 | Bal. | 85 | 14 | 514 | 408 | 289 | 119 | 136 | 564 | 2.7 |
| 1.5:1 | 13.5 | 1 | 1.3 | 1.3 | 0.1 | 1.3 | 0.3 | 1.5 | 1 | Bal. | 85 | 16 | 521 | 394 | 275 | 119 | 136 | 564 | 2.7 |
| 2.3:1 | 13.5 | 1 | 1.3 | 1.3 | 0.1 | 1.3 | 0.3 | 2.3 | 1 | Bal. | 86 | 14 | 510 | 409 | 289 | 120 | 135 | 564 | 2.8 |
| 3.5:1 | 13.5 | 1 | 1.3 | 1.3 | 0.1 | 1.3 | 0.3 | 3.5 | 1 | Bal. | 88 | 14 | 515 | 388 | 270 | 118 | 129 | 584 | 2.8 |
| 5:1 | 13.5 | 1 | 1.3 | 1.3 | 0.1 | 1.3 | 0.3 | 5 | 1 | Bal. | 92 | 13 | 515 | 383 | 265 | 118 | 123 | 590 | 2.8 |
| 1:1.5 | 13.5 | 1 | 1.3 | 1.3 | 0.1 | 1.3 | 0.3 | 1 | 1.5 | Bal. | 86 | 16 | 516 | 421 | 301 | 120 | 134 | 564 | 2.7 |
| 1:2.5 | 13.5 | 1 | 1.3 | 1.3 | 0.1 | 1.3 | 0.3 | 1 | 2.5 | Bal. | 88 | 16 | 506 | 269 | 167 | 102 | 131 | 595 | 2.8 |
| 1:3.5 | 13.5 | 1 | 1.3 | 1.3 | 0.1 | 1.3 | 0.3 | 1 | 3.5 | Bal. | 91 | 16 | 499 | 354 | 238 | 116 | 128 | 601 | 2.8 |
| 2.3:2.5 | 13.5 | 1 | 1.3 | 1.3 | 0.1 | 1.3 | 0.3 | 2.3 | 2.5 | Bal. | 90 | 16 | 504 | 270 | 167 | 103 | 131 | 597 | 2.8 |

Table 1 shows a fraction of reinforcing phase depending on the composition ratio of Ti:B:Cu, and Table 2 shows a change in physical properties depending on the composition ratio of Ti:B (Cu: 1.3 wt %, initial cooling speed 20° C./s).

As shown in Table 1, when the content of Cu is equal to or more than 1.5 wt %, the thermal stability is slightly increased, but as the Al₇Cu₄Ni phase which adversely affects the thermal conductivity is generated by 1 wt % or more, the thermal conductivity (300° C.) is reduced and thus the thermal conduction loss is increased, which is not suitable as a material of parts, which are used under the high temperature condition, of the piston of the automobile, and the like.

Therefore, the content of Cu may be limited to be less than 1.5 wt %.

Meanwhile, Table 2 shows a change in physical properties depending on the composition ratio of Ti and B which affect the elasticity and the formability in the state in which the content of Cu is fixed to 1.3 wt %. It may be appreciated from Table 2 that when the content of Ti is equal to or more than 2.5 wt %, the TiB₂ phase and the Al₃Ti phase which are the reinforcing phases are generated, and thus the elasticity is increased but the thermal conductivity is reduced. When the content of Ti is equal to or less than 0.5 wt %, the generation quantity of the TiB₂ phase as the reinforcing phase having the excellent elasticity, formability, and thermal properties is reduced and thus the formability and the thermal properties are reduced.

Therefore, the content of Ti may be limited to 0.5 to 2.5 wt %.

Further, it may be appreciated that when the content of B is equal to or greater than 1.5 wt %, it may be appreciated that the elasticity is increased but the thermal properties such as thermal conductivity are reduced, due to the excessive generation of the TiB₂ phase and the AlB₂ phase which are the reinforcing phases.

On the other hand, in accordance with the exemplary embodiment of the present invention, it may be appreciated that when the composition ratio of Ti:B:Cu is set to satisfy 0.5 to 2.5:1:1 to 1.3, Ti is less than 2.5 wt % (except for 0), B is less than 1.5 wt % (except for 0), and Cu is 0.5 to 1.5 wt %, the generation of the TiB₂ phase is maximized to suppress the generation of the Al₃Ti phase having the poor formability and impact properties, thereby improving both elasticity and formability while preventing the thermal properties of the material from reducing.

TABLE 3

| | | | | | | | | | | | | | Thermal | Coefficient of | | |
|---|---|---|---|---|---|---|---|---|---|---|---|---|---|---|---|---|
| | | | | | | | | | | | | | Conduc- | Thermal | Den- | Melting |
| | | | | | | | | | | | Modulus | DAS | tivity | Expansion | sity | Point |
| Division | Si | Fe | Cu | Mn | Mg | Cr | Zn | Ti | B | Al | Gpa | μm | 300° C. | ~500° C. | g/cm³ | ° C. |
| 4032 | 11~14 | 1 | 0.5~1.3 | 0.8~1.3 | 0.1 | 0.5~1.3 | ≦0.25 | — | — | Bal. | 81 | 15.7 | 143 | 24.5 | 2.72 | 566 |
| Example | 13.5 | 1 | 1.3 | 1.3 | 0.1 | 1.3 | 0.25 | 2.3 | 1 | Bal. | 86 | 14 | 135 | 23.9 | 2.75 | 564 |

Table 3 shows comparing characteristics such as elasticity and formability of the commercial 4000 series aluminum alloy (4032) which is mainly used as the material of the engine piston of the automobile in accordance with the related art with those of the aluminum alloy for an engine piston of an automobile in accordance with the exemplary embodiment of the present invention.

It may be appreciated that from Table 3, by adding the contents of Ti, B, and Cu to the existing composition component of the commercial 4000 series aluminum alloy while controlling the contents of Ti, B, and Cu, the aluminum alloy for an engine piston of an automobile in accordance with the exemplary embodiment of the present invention shows the equivalent thermal properties of the thermal conductivity and the coefficient of thermal expansion to those of the commercial 4000 series aluminum alloy, but has elasticity improved by about 7% and has a slightly reduced dendrite arm spacing (DAS) value showing formability to improve the formability, comparing with the commercial 4000 series aluminum alloy.

Therefore, the aluminum alloy for an engine piston of an automobile in accordance with the exemplary embodiment of the present invention has the improved elasticity and the high-temperature dimensional stability over the existing commercial 4000 series aluminum alloy, thereby improving the stiffness and NVH characteristics of the parts of the engine piston, and the like which are used under the severe condition.

A method for producing an aluminum alloy for an engine piston of an automobile in accordance with the exemplary embodiment of the present invention includes charging Al—Ti master alloy, Al—B master alloy or 75 wt % of Al salt compound in Al molten metal which is received in a melting furnace and agitating the molten metal so as to generate and disperse the TiB₂ phase which is the reinforcing phase.

In the charging, at least any one of the Al—Ti master alloy, the Al—B master alloy, and 75 wt % of Al salt compound may be charged so that the composition ratio of Ti:B in the molten metal is set to satisfy 2.5 to 5.5:1.

In this case, Ti may be less than 2.5 wt % (except for 0) and the content of B may be less than 1.5 wt % (except for 0). The reason is as the above description.

Further, the Al—Ti master alloy which is charged in the molten metal may be composed of Ti: 5 to 20 wt % and the balance: Al and the Al—B master alloy may be composed of B: 3 to 10 wt % and the balance: Al.

By keeping the above ratio, it is possible to minimize the generation of the reinforcing phases having the poor formability and thermal properties while maximizing the generation of the TiB₂ phase which may have the excellent thermal properties, elasticity, and formability.

In the agitating, it is preferable to agitate the molten metal at a speed of 500 rpm or more by using an agitator having a length of 0.4 times or more than a diameter of the melting furnace so that the TiB₂ phase which is the reinforcing phase may be generated and dispersed.

The length and the agitation speed of the agitator affect the reaction speed and the dispersion of the reinforcing phase. Therefore, the length of the agitator needs to be set to be 40% or more of the melting furnace. When the agitation speed is less than 500 rpm, the Al₃Ti phase having the poor formability and impact properties is generated and the generation quantity of the TiB₂ phase is insufficient, and as a result the formability and the impact properties are reduced.

Further, the generated reinforcing phase is not uniformly dispersed and thus a deviation in physical properties may occur depending on the portion of the molten metal.

The method for producing an aluminum alloy for an engine piston of an automobile in accordance with the related art mainly injects the carbon nano tube or the reinforcing particles in a powder form to improve the elasticity but causes the loss, the wettability, the dispersion, and the like in the molten metal and causes the producing costs, while the present invention may maximize the generation of the TiB₂ phase and uniformly disperse TiB₂ phase in the molten metal while suppressing the generation of the reinforcing phase such as the Al₃Ti phase having the poor formability and the impact properties by controlling the composition ratio, thereby making the thermal properties excellent and improving characteristics such as elasticity, and formability, and the like.

In accordance with the exemplary embodiments of the present invention, it is possible to make the thermal properties such as thermal conductivity and thermal expandability of a material, the formability, and the elasticity excellent by optimizing the composition ratio of Ti, B, and Cu to suppress the generation of the Al₃Ti phase and the AlB₂ phase while maximizing the generation of the TiB₂ phase which is the reinforcing phase.

Further, it is possible to uniformly disperse the boride compound which is the reinforcing phase by agitating under the optimum conditions the TiB₂ phase and the AlB₂ phase which are generated by the spontaneous reaction within the aluminum molten metal.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. An aluminum alloy for an engine piston of an automobile, comprising Ti, B, Cu and a balance of Al and including a TiB₂ phase as a reinforcing phase, wherein a composition weight ratio of Ti:B:Cu is 0.5 to 2.5:1:1 to 1.3.

2. The aluminum alloy of claim 1, further comprising Si,
wherein Si is 11 to 14 wt % of the aluminum alloy, Ti is less than 2.5 wt % (except for 0) of the aluminum alloy, B is less than 1.5 wt % (except for 0) of the aluminum alloy, and Cu is 0.5 to 1.5 wt % of the aluminum alloy.

3. The aluminum alloy of claim 1, further comprising Mn,
wherein Mn is 1 to 1.5 wt % of the aluminum alloy, Ti is less than 2.5 wt % (except for 0) of the aluminum alloy, B is less than 1.5 wt % (except for 0) of the aluminum alloy, and Cu is 0.5 to 1.5 wt % of the aluminum alloy.

4. A method for producing an aluminum alloy, comprising steps of:
charging Al—Ti master alloy, Al—B master alloy or 75 wt % of Al salt compound in Al molten metal which is received in a melting furnace, in which Ti is less than 2.5 wt % (except for 0) of the aluminum alloy, B is less than 1.5 wt % (except for 0) of the aluminum alloy, Cu is 0.5 to 1.5 wt % of the aluminum alloy, and the composition weight ratio of Ti:B:Cu is set to satisfy 0.5 to 2.5:1:1 to 1.3; and
agitating the molten metal using an agitator so as to generate and disperse a TiB₂ phase which is a reinforcing phase by a spontaneous reaction.

5. The method of claim 4, wherein a length of the agitator is set to be 0.4 times or more than a diameter of the melting furnace, and
in the step of agitating, the molten metal is agitated at a speed of 500 rpm or more.

6. The method of claim 4, wherein the Al—Ti master alloy is composed of Ti: 5 to 20 wt % and a balance of Al.

7. The method of claim 4, wherein the Al—B master alloy is composed of B: 3 to 10 wt % and a balance of Al.
